(19) United States
(12) Patent Application Publication
(10) Pub. No.: US 2026/0290984 A1
(43) Pub. Date: Sep. 24, 2026

(54) BATTERY MODULE

(71) Applicant: Panasonic Intellectual Property Management Co., Ltd., Osaka (JP)

(72) Inventors: Kazuhiro KAWAMURA, Hyogo (JP); Yusuke OKII, Osaka (JP); Keita YAMAUCHI, Osaka (JP); Yosuke SAWA, Hyogo (JP); Takuya SAIKI, Osaka (JP)

(21) Appl. No.: 19/406,501

(22) Filed: Dec. 2, 2025

Related U.S. Application Data
(63) Continuation of application No. PCT/JP2025/019973, filed on Jun. 3, 2025.

(30) Foreign Application Priority Data
Mar. 21, 2025 (JP) 2025-046704

(51) Int. Cl. H01M 50/291; H01M 50/213; H01M 50/244; H01M 50/258; H01M 50/293; H01M 50/507; H01M 50/51

(52) U.S. Cl. CPC H01M 50/291; H01M 50/213; H01M 50/244; H01M 50/258; H01M 50/293; H01M 50/507; H01M 50/51

(57) ABSTRACT

A battery module includes: a plurality of dividing holders each accommodating one end of each of a plurality of battery blocks and connecting at least a part of a plurality of battery cells included in each of the plurality of battery blocks in parallel to each other; a bus bar that is detachable and electrically connecting the plurality of dividing holders so as to connect the plurality of battery blocks in series; and one base holder accommodating the other ends of the plurality of battery blocks so as to sandwich the plurality of battery blocks together with the plurality of dividing holders.

### CROSS REFERENCE TO RELATED APPLICATION

This is a continuation application claiming priority of International Patent Application No. PCT/JP2025/019973 with an international filing date of Jun 3, 2025, which claims priority of Japanese Patent Application No. 2025-046704 filed on March 21, 2025, the entire contents of which are incorporated herein by reference.

### BACKGROUND

### Technical Field

The present disclosure relates to a battery module.

### Background Art

WO 2016/31208 A discloses a battery module including a plurality of dividing holders each accommodating a plurality of battery cells. In the battery module, the plurality of battery cells are sandwiched and electrically connected between a positive-electrode current collecting plate and a negative-electrode current collecting plate. The structure in which the current collecting plate is disposed so as to sandwich the plurality of battery cells is referred to as a both-side current collecting structure.

### SUMMARY

WO 2016/31208 A discloses a concept of handling a plurality of battery cells divided into groups, but since a both-side current collecting structure is adopted, a plurality of dividing holders are integrally formed in a non-detachable manner. Therefore, it is difficult to replace only some dividing holders, and there is room for improvement.

An object of the present disclosure is to provide a battery module in which a part is easily replaced.

The present disclosure provides a battery module including:

a plurality of dividing holders that respectively accommodate one ends of a plurality of battery blocks and connect at least some of a plurality of battery cells included in each of the plurality of battery blocks in parallel with each other;

a series connection portion that is detachable and electrically connects the plurality of dividing holders so as to connect the plurality of battery blocks in series; and

one base holder that accommodates the other ends of the plurality of battery blocks so as to sandwich the plurality of battery blocks together with the plurality of dividing holders.

According to the present disclosure, it is possible to provide a battery module in which a part is easily replaced.

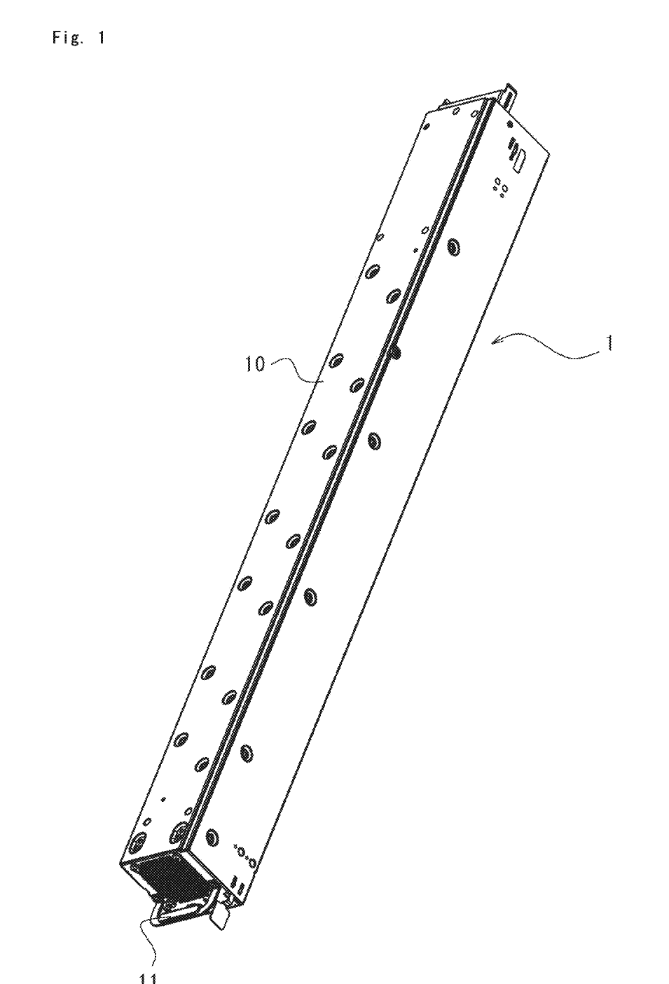

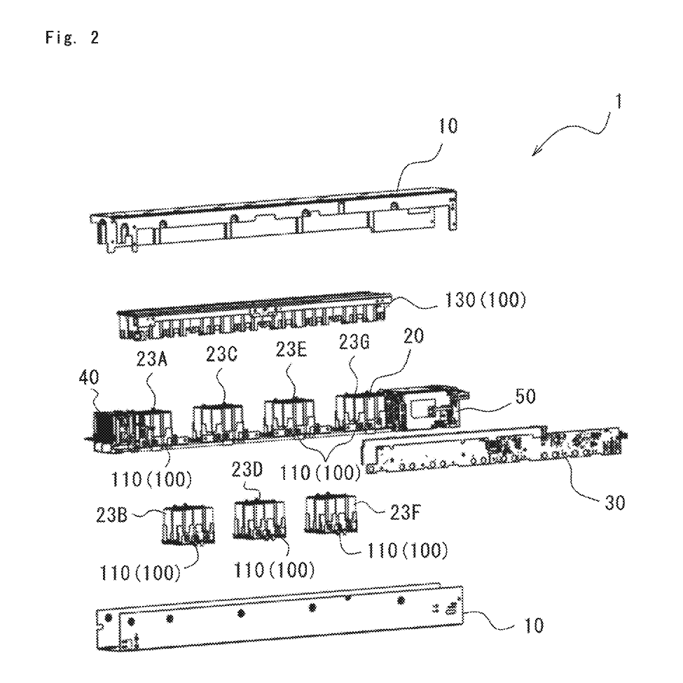

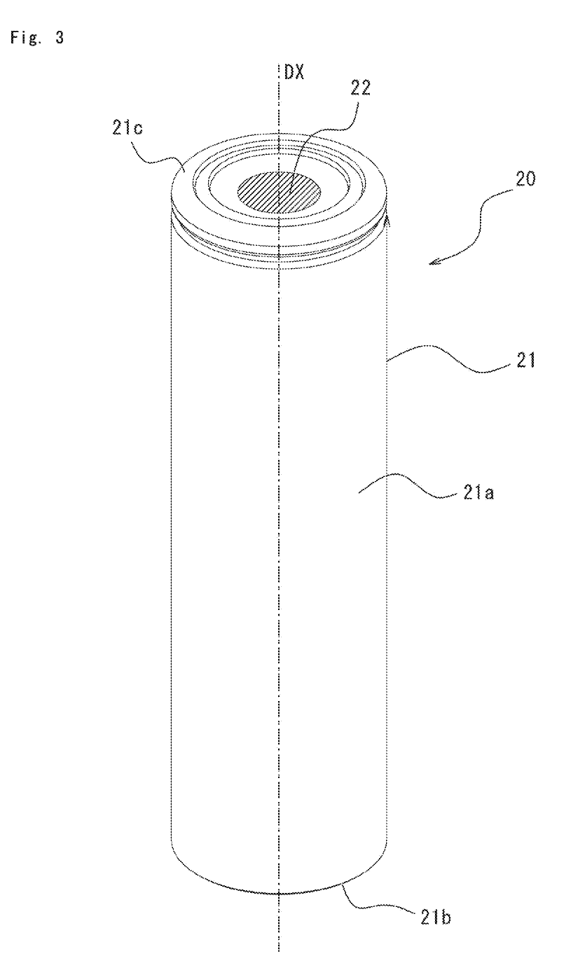

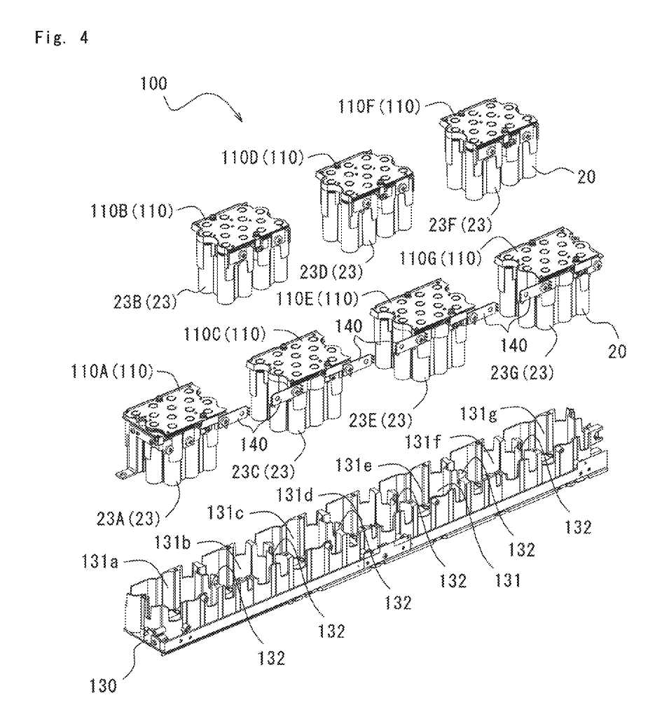

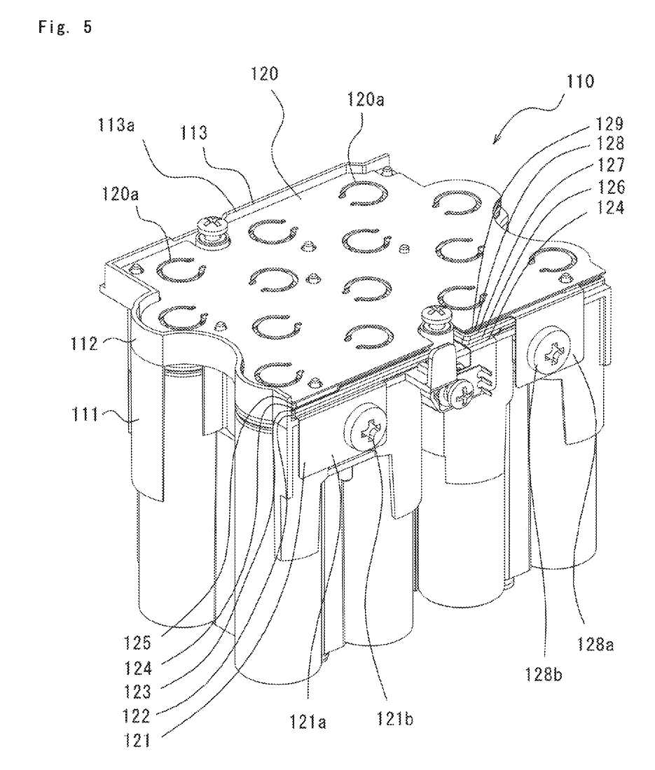

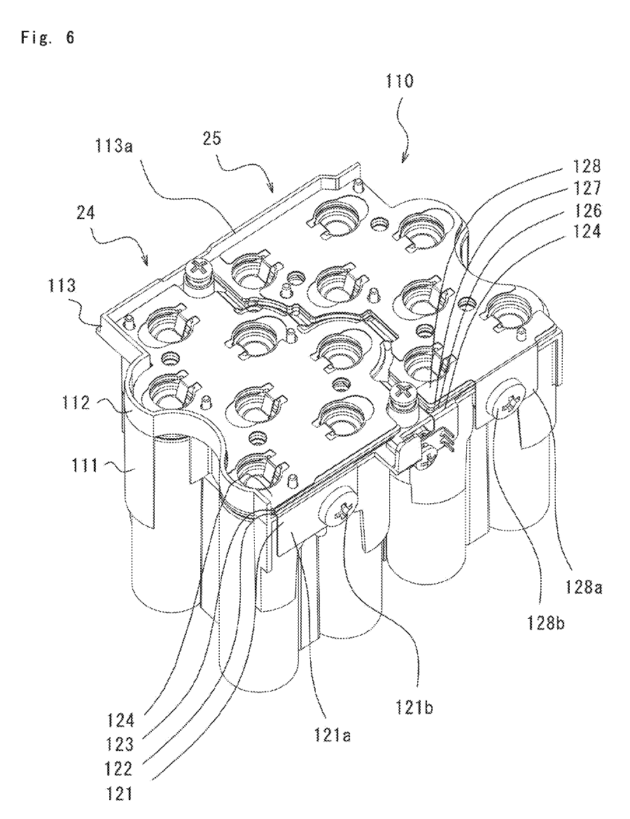

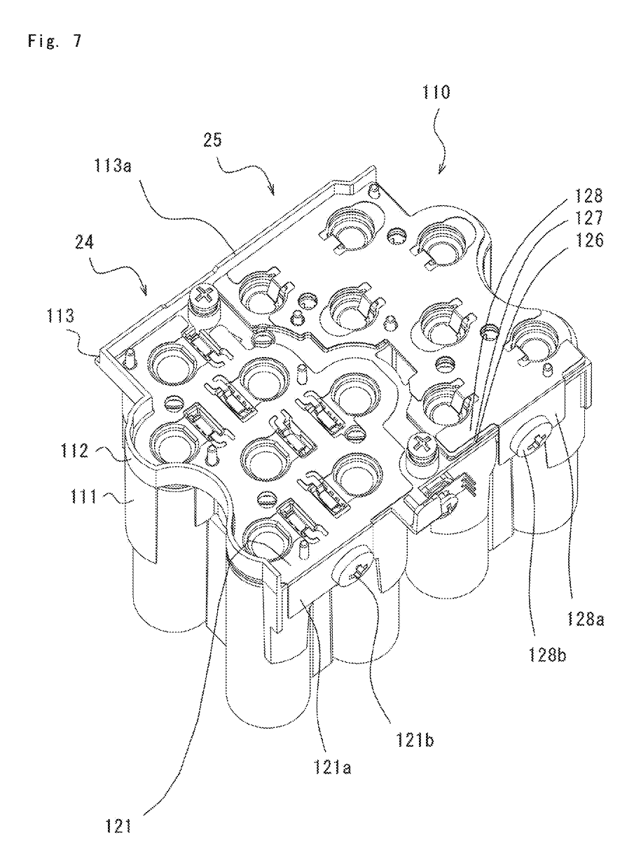

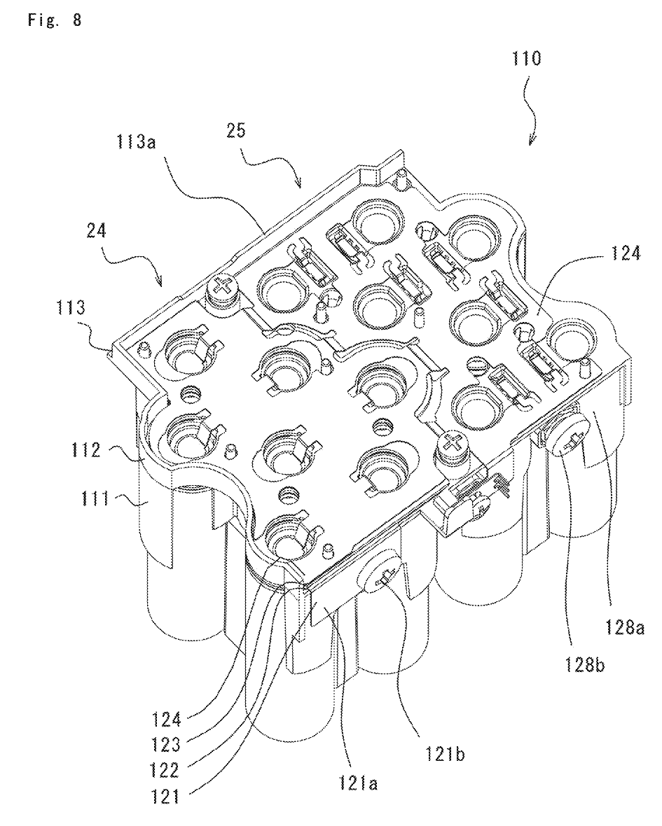

### BRIEF DESCRIPTION OF THE DRAWINGS

[FIG. 1] FIG. 1 is a perspective view of a battery module according to an embodiment of the present disclosure.

[FIG. 2] FIG. 2 is an exploded perspective view of a battery module.

[FIG. 3] FIG. 3 is a perspective view of a battery cell.

[FIG. 4] FIG. 4 is an exploded perspective view of a cell holder.

[FIG. 5] FIG. 5 is a perspective view illustrating a dividing holder.

[FIG. 6] FIG. 6 is a first perspective view illustrating a current collecting structure.

[FIG. 7] FIG. 7 is a second perspective view illustrating a current collecting structure.

[FIG. 8] FIG. 8 is a third perspective view illustrating a current collecting structure.

### DETAILED DESCRIPTION

Hereinafter, specific examples of the present disclosure will be described in detail with reference to the drawings. In the following description, terms indicating specific directions and positions may be used as necessary, but these terms are used to facilitate understanding of the invention with reference to the drawings, and the technical scope of the present disclosure is not limited by the meanings of these terms. Parts denoted by the same reference numerals in a plurality of drawings indicate the same or equivalent parts or members. Furthermore, the following embodiments illustrate specific examples of the technical idea of the present disclosure, and do not limit the present disclosure to the following. In addition, dimensions, materials, shapes, relative arrangements, and the like of the components described below are not intended to limit the scope of the present disclosure only to the dimensions, materials, shapes, relative arrangements, and the like unless otherwise specified, and are intended to be illustrative. The contents described in one embodiment and example are also applicable to other embodiments and examples. In addition, sizes, positional relationships, and the like of members illustrated in the drawings may be exaggerated for clarity of description.

FIG. 1 shows a battery module 1 according to an embodiment of the present disclosure.

### Application

A battery module 1 is applied to, for example, an emergency power supply such as a battery backup unit (BBU), a power supply of a traveling motor of an electric vehicle, and the like. However, the application of the battery module 1 is not particularly limited, and the battery module 1 can be used as a power supply for various other electric devices.

### Exterior

The battery module 1 has a box-shaped exterior case 10 extending in the longitudinal direction. A carrying handle 11 is attached to one end of the exterior case 10 in the longitudinal direction. Although not illustrated in detail, a connector for supplying power is provided at the other end of the exterior case 10 in the longitudinal direction.

### Overall Structure

FIG. 2 is an exploded perspective view of the battery module 1.

The battery module 1 includes, in the exterior case 10, a plurality of battery cells 20, a cell holder 100 that accommodates the plurality of battery cells 20 so as to sandwich the plurality of battery cells 20, a substrate 30, a fan device 40, and a control device 50. The exterior case 10 is divided into upper and lower parts.

### Battery Cell

FIG. 3 is a perspective view illustrating one of the plurality of battery cells 20.

In the present embodiment, each of the plurality of battery cells 20 is a cylindrical lithium ion secondary battery. Each of the plurality of battery cells 20 has an exterior can 21 and a cap 22. The exterior can 21 has a bottomed cylindrical shape having an opening at one end (upper end in FIG. 3) in the axial direction DX, and constitutes a negative electrode terminal. The cap 22 is disposed at one end in the axial direction DX, seals an opening of the exterior can 21 with an insulating material interposed therebetween, and constitutes a positive electrode terminal (see a hatched portion). That is, each of the plurality of battery cells 20 constitutes a positive electrode terminal at the cap 22 at the center of the top portion, and constitutes a negative electrode terminal at a side surface portion 21a, a bottom surface portion 21b, and a top edge 21c. Note that the polarity may be configured to be opposite to this. In the present embodiment, the battery module 1 includes 98 battery cells 20. The 98 battery cells 20 are divided into seven battery blocks 23A to 23G. Each of the seven battery blocks 23A to 23G includes 14 battery cells 20. However, these numbers can be appropriately changed according to a necessary design. Hereinafter, when the seven battery blocks 23A to 23G are described without distinction, they are also simply referred to as battery blocks 23.

### Cell Holder

FIG. 4 shows a perspective view of the cell holder 100. Note that FIG. 4 is illustrated upside down with respect to FIG. 2.

In the present embodiment, the cell holder 100 includes seven dividing holders 110A to 110G and one base holder 130. However, the number of dividing holders can be appropriately changed according to a necessary design. Hereinafter, the seven dividing holders 110A to 110G are also simply referred to as dividing holders 110 in a case where they are not distinguished from one another.

FIG. 5 is a perspective view illustrating the dividing holder 110.

The dividing holder 110 accommodates one end (upper end in FIGS. 4 and 5) of battery block 23. The dividing holder 110 is made of an insulating material such as synthetic resin, and is formed by injection molding, for example. The dividing holder 110 includes a cell accommodating portion 111 that accommodates one ends of the plurality of battery cells 20, and a placement portion 112 on which an insulating sheet 120 and the like are placed.

The cell accommodating portion 111 has a shape complementary to one ends of the plurality of battery cells 20. In the illustrated example, the cell accommodating portion 111 holds 14 battery cells 20 arranged in a zigzag manner.

The placement portion 112 has an edge 113 including a rib 113a rising from the cell accommodating portion 111 to the side opposite to the plurality of battery cells 20. Inside the rib 113a, a current collecting structure including an insulating sheet 120, several current collecting plates, and several lead plates is formed. Although the current collecting structure will be described later, only the uppermost insulating sheet 120 can be visually recognized in FIG. 5. The insulating sheet 120 is provided with a plurality of C-shaped gas vent holes 120a having a function as a gas vent valve.

FIG. 6 is a first perspective view illustrating the current collecting structure. FIG. 6 illustrates a state in which the insulating sheet 120, a current collecting plate 125 to be described later, and a current collecting plate 129 to be described later are removed from FIG. 5.

In the present exemplary embodiment, each of the plurality of battery blocks 23 includes a first parallel block 24 (front left side in FIG. 6) in which seven battery cells 20 are connected in parallel, and a second parallel block 25 (back right side in FIG. 6) in which seven battery cells 20 are similarly connected in parallel. Each of the plurality of dividing holders 110 accommodates the first parallel block 24 and the second parallel block 25 side by side.

On the first parallel block 24 side, a lead plate 121, a current collecting plate 122, an insulating sheet 123, a lead plate 124, and the current collecting plate 125 (see FIG. 5) are stacked in this order from the bottom. Similarly, on the second parallel block side, the lead plate 124, a current collecting plate 126, an insulating sheet 127, a lead plate 128, and a current collecting plate 129 (see FIG. 5) are stacked in this order from the bottom. The lead plate 124 is disposed across the first parallel block 24 and the second parallel block 25.

FIG. 7 is a second perspective view illustrating the current collecting structure. FIG. 7 shows a state where the current collecting plate 122, the insulating sheet 123, the lead plate 124, and the current collecting plate 125 on the first parallel block 24 side, and the lead plate 124 and the current collecting plate 129 on the second parallel block 25 side are removed from FIG. 6.

FIG. 8 is a third perspective view illustrating the current collecting structure. FIG. 8 shows a state where the current collecting plate 126, the insulating sheet 127, the lead plate 128, and the current collecting plate 129 on the second parallel block 25 side are removed from FIG. 6.

Referring to FIG. 7, top edges (negative electrode terminals) 21c of the plurality of battery cells 20 of the first parallel block 24 are electrically connected to the lead plate 121. Here, the top edge (negative electrode terminal) 21c and the lead plate 121 are welded. The same applies to subsequent electrical connection between the lead plates 124 and 128 and the plurality of battery cells 20. The lead plate 121 has a tab 121a extending so as to hang down on the side surface portion. The tab 121a is provided with a hole for fastening with a bus bar 140 (see FIG. 4) to be described later, and a screw 121b is attached to the hole.

Referring to FIG. 8, the caps (positive electrode terminals) 22 of the plurality of battery cells 20 of the first parallel block 24 are electrically connected to the lead plate 124. The lead plate 124 is also electrically connected to top edges (negative electrode terminals) 21c of the plurality of battery cells 20 of the second parallel block 25. Therefore, the first parallel block 24 and the second parallel block 25 are connected in series.

Referring to FIG. 7, the caps (positive electrode terminals) 22 of the plurality of battery cells 20 of the second parallel block 25 are electrically connected to the lead plate 128. The lead plate 128 has a tab 128a extending so as to hang down on the side surface portion. The tab 128a is provided with a hole for fastening with a bus bar 140 (see FIG. 4) to be described later, and a screw 128b is attached to the hole.

Referring to FIG. 4, the tab 121a on the first parallel block 24 side of a dividing holder (for example, 110B) is electrically connected via a plurality of bus bars (series connection portions) 140 reversibly joined to the tab 128a on the second parallel block 25 side of another dividing holder (for example, 110A). The tab 128a on the second parallel block 25 side of one dividing holder (for example, 110B) is electrically connected via a plurality of bus bars (series connection portions) 140 reversibly joined to the tab 121a on the first parallel block 24 side of another dividing holder (for example, 110C). Here, "reversibly joining" refers to joining that can be easily released, and in the present embodiment, the bus bar 140 is configured to be detachable.

The bus bar 140 is a metal plate having conductivity. The tabs 121a and 128a and the bus bar 140 are fastened by the screws 121b and 128b. By releasing the fastening by the screws 121b and 128b and removing the bus bar 140, the electrical connection between the plurality of dividing holders 110 can be easily released.

The base holder 130 accommodates the other ends (lower ends in FIG. 4) of the plurality of battery blocks 23. The base holder 130 is made of an insulating material such as synthetic resin, and is formed by injection molding, for example. The base holder 130 includes cell accommodating portions 131 that accommodate the plurality of battery blocks 23 so as to sandwich the plurality of battery blocks 23 together with the plurality of dividing holders 110. The base holder 130 has a partition wall 132 between the dividing holders 110.

The cell accommodating portion 131 has a shape complementary to the other ends (lower ends in FIG. 4) of the plurality of battery cells 20, and accommodates the other ends of the plurality of battery cells 20. In the illustrated example, the cell accommodating portion 131 is partitioned into seven accommodation regions 131a to 131g corresponding to the seven dividing holders 110A to 110G. The seven accommodation regions 131a to 131g are partitioned from each other by the partition wall 132. The partition wall 132 is a part of the base holder 130, and is not formed separately from the cell accommodating portion 131 but is formed integrally. In other words, the base holder 130 includes a single component. As a whole, the cell accommodating portion 131 holds 98 battery cells 20 arranged in a zigzag manner. The base holder 130 has a length substantially equal to the total length of the plurality of dividing holders 110A to 110G.

The base holder 130 does not have a structure for providing electrical connection to the plurality of battery cells 20, and does not have a conductive member such as a lead plate or a current collecting plate. In other words, in the battery module 1 of the present embodiment, a one-side current collecting structure in which electrical connection structures are aggregated on the plurality of dividing holders 110 side is adopted. In the one-side current collecting structure, the base holder 130 does not involve complicated fixing such as welding to the plurality of battery cells 20. Therefore, the plurality of battery cells 20 can be easily inserted into and removed from the base holder 130.

### Substrate

Referring to FIG. 2, the substrate 30 is disposed adjacent to the cell holder 100. The substrate 30 has various control functions together with the control device 50 described later.

### Fan Device

Referring to FIG. 2, the fan device 40 is disposed on one end side (left side in FIG. 2) of the cell holder 100 in the longitudinal direction. The fan device 40 includes a fan that takes in outside air, blows the air to the plurality of battery cells 20, and cools the plurality of battery cells 20 by air.

### Control Device

Referring to FIG. 2, the control device 50 is disposed on the other end side (right side in FIG. 2) of the cell holder 100 in the longitudinal direction. The control device 50 has various control functions together with the substrate.

### Operational Effects

According to the battery module 1 according to the above embodiment, the following operational effects can be achieved.

Since the bus bar 140 and the dividing holder 110 are detachably connected to each other by the screws 121b and 128b, connection between the plurality of battery blocks 23 can be released by removing the bus bar 140. As a result, each of the plurality of dividing holders 110 can be easily taken out from the base holder 130. For example, when an abnormality is found only in a part of the plurality of battery blocks 23, only the dividing holder 110 that accommodates the battery block 23 in which the abnormality is found can be taken out and replaced.

Since the structure having the electrical connection exists only in the plurality of dividing holders 110 and does not exist in the base holder 130, it is possible to easily take out each dividing holder 110 by disconnecting the electrical connection of the plurality of dividing holders 110.

In addition, since the cell holder 100 is divided, the welding between the lead plates 121, 124, and 128 and the plurality of battery cells 20 can be performed in a small range for each of the plurality of dividing holders 110. When the cell holder 100 is not divided, a large-scale welding facility is required, but the division as in the present embodiment enables a small-scale welding facility. Accordingly, parallel welding can be performed, and the lead time of the welding step can be shortened. Furthermore, restrictions required for large welding equipment can be relaxed for finishing accuracy and processing accuracy.

In addition, since the bus bar (DC connection unit) 140 is attached to the side surface portion of each of the plurality of dividing holders 110, the bus bar 140 can be easily attached and detached.

In addition, since the plurality of bus bars 140 reversibly joined as DC connection units between the plurality of dividing holders 110 are adopted, DC connection can be realized with a simple configuration.

In addition, since the base holder 130 has the partition wall 132 between the dividing holders 110, it is possible to realize improvement in safety due to enhancement of insulation between the dividing holders 110.

In addition, since the rib exists on the edge 113 of the dividing holder 110, the strength of the dividing holder alone is improved, and workability and safety at the time of attachment and disassembly are improved.

In each of the plurality of dividing holders 110, the plurality of battery cells 20 are connected in parallel and in direct current, so that a high degree of freedom in designing voltage, arrangement, and the like can be secured. In addition, the number of the tabs 121a and 128a and the bus bars 140 can be reduced and the configuration can be simplified as compared with a configuration in which no DC connection is established in the plurality of dividing holders 110.

Although the embodiment has been described so far, various modifications can be made to the above configuration within the scope of the gist of the present disclosure.

In the above embodiment, the plurality of battery cells 20 are lithium ion batteries, but may be secondary batteries other than lithium ion batteries such as all-solid batteries.

In the above embodiment, the example in which the DC connection unit between the plurality of dividing holders 110 is the bus bar 140 has been described, but the DC connection unit may be formed of another conductive member such as a lead wire or a substrate.

The present disclosure may include the following aspects.

### Aspect 1

A battery module including:

a plurality of dividing holders that respectively accommodate one ends of a plurality of battery blocks and connect at least some of a plurality of battery cells included in each of the plurality of battery blocks in parallel with each other;

a series connection portion that is detachable and electrically connects the plurality of dividing holders so as to connect the plurality of battery blocks in series; and

one base holder that accommodates the other ends of the plurality of battery blocks so as to sandwich the plurality of battery blocks together with the plurality of dividing holders.

### Aspect 2

The battery module according to aspect 1, in which the series connection portion is attached so as to connect side surfaces of the plurality of dividing holders.

### Aspect 3

The battery module according to aspect 1 or 2, in which the series connection portion includes a plurality of bus bars reversibly joined.

### Aspect 4

The battery module according to aspect 3, in which the plurality of reversibly joined bus bars are fastened to the plurality of dividing holders by screws.

### Aspect 5

The battery module according to any one of aspects 1 to 4, in which

each of the plurality of battery blocks includes a first parallel block in which a plurality of battery cells are connected in parallel to each other, and a second parallel block in which another plurality of battery cells are connected in parallel to each other, and

each of the plurality of dividing holders connects the first parallel block and the second parallel block in series.

### Aspect 6

The battery module according to any one of aspects 1 to 5, in which the base holder is made of an insulating material.

### Aspect 7

The battery module according to any one of aspects 1 to 6, in which the base holder includes a partition wall between the dividing holders adjacent to each other.

### Aspect 8

The battery module according to any one of aspects 1 to 7, in which the plurality of dividing holders include ribs at edges.

What is claimed is:

1. A battery module including:
a plurality of dividing holders that respectively accommodate one ends of a plurality of battery blocks and connect at least some of a plurality of battery cells included in each of the plurality of battery blocks in parallel with each other;
a series connection portion that is detachable and electrically connects the plurality of dividing holders so as to connect the plurality of battery blocks in series; and
one base holder that accommodates the other ends of the plurality of battery blocks so as to sandwich the plurality of battery blocks together with the plurality of dividing holders, wherein
the series connection portion is attached so as to connect side surfaces of the plurality of dividing holders,
the series connection portion includes a plurality of bus bars reversibly joined,
the plurality of reversibly joined bus bars are fastened by screws to tabs of lead plates that extend downward along side surfaces of the plurality of dividing holders, and
an inserting and removing direction of the screws with respect to holes of the tabs is perpendicular to the side surfaces of the plurality of divided holders.

2. The battery module according to claim 1, wherein
each of the plurality of battery blocks includes a first parallel block in which a plurality of battery cells are connected in parallel to each other, and a second parallel block in which another plurality of battery cells are connected in parallel to each other, and
each of the plurality of dividing holders connects the first parallel block and the second parallel block in series.

3. The battery module according to claim 1, wherein the base holder is made of an insulating material.

4. The battery module according to claim 1, wherein the base holder includes a partition wall between the dividing holders adjacent to each other.

5. The battery module according to claim 1, wherein the plurality of dividing holders include ribs at edges.
